(19) United States
(12) Patent Application Publication
(10) Pub. No.: US 2015/0378094 A1
(43) Pub. Date: Dec. 31, 2015

(54) OPTICAL FIBER WITH IMAGE ENHANCEMENT

(71) Applicants: LUKE LU, Taipei City (TW); YU-PING TSAI, Taipei City (TW)

(72) Inventors: LUKE LU, Taipei City (TW); YU-PING TSAI, Taipei City (TW)

(73) Assignee: TAIWAN FIBER OPTICS, INC., Taipei City (TW)

(21) Appl. No.: 14/843,774

(22) Filed: Sep. 2, 2015

Related U.S. Application Data
(62) Division of application No. 14/322,798, filed on Jul. 2, 2014.

(30) Foreign Application Priority Data
Aug. 9, 2013 (TW) 102128625

(51) Int. Cl. G02B 6/08; G02B 5/30

(52) U.S. Cl. CPC G02B 6/08; G02B 5/3033

(57) ABSTRACT

An optical fiber with image enhancement is provided with, in combination an elongated optical fiber unit including an image input surface on a bottom, an image output surface on a top, and a light guide member between the image input surface and the image output surface. The elongated optical fiber unit is a triangular sectional structure having a vertical surface and an inclined surface, and length of the image output surface is greater than that of the image input surface. The elongated optical fiber unit is configured to seamlessly fasten in a joining portion of two rectangular panels so that light is configured to pass through the image input surface, the light guide member, and the image output surface.

### CROSS-REFERENCES TO RELATED APPLICATIONS

This is a divisional application of pending U.S. patent application Ser. No. 14/322,798 filed Jul. 2, 2014. The entirety of the above-mentioned patent application is hereby incorporated by reference herein and made a part of specification.

### BACKGROUND OF THE INVENTION

1. Field of the Invention

The invention relates to digital imaging and more particularly to a fiber optics faceplate with image enhancement.

2. Description of Related Art

Screens of computers and televisions are made bigger as technologies advance and demands. However, a large screen may be made by joining a number of small panels due to the consideration of cost or technological limitations. Thus, a joining portion 30a of two conventional panels may have a poor image quality as shown in FIG. 20.

Thus, the need for improvement still exists.

### SUMMARY OF THE INVENTION

It is therefore one object of the invention to provide a fiber optics faceplate comprising, in combination an elongated fiber optics faceplate unit including an image input surface on a bottom, an image output surface on a top, and a light guide member between the image input surface and the image output surface; wherein the elongated fiber optics Faceplates unit is a triangular sectional structure having a vertical surface and an inclined surface, and length of the image output surface is greater than that of the image input surface; and wherein the elongated fiber optic faceplate unit is configured to seamlessly fasten in a joining portion of two rectangular panels so that light is configured to pass through the image input surface, the light guide member, and the image output surface.

The above and other objects, features and advantages of the invention will become apparent from the following detailed description taken with the accompanying drawings.

### BRIEF DESCRIPTION OF THE DRAWINGS

FIG. 1 is a perspective view of a fiber optics faceplate with image enhancement according to a first preferred embodiment of the invention;

FIG. 2 schematically depicts a forming of the elongated fiber optics faceplate unit with image enhancement by pressing fiber optics;

FIG. 3 shows two different perspective views of the elongated fiber optic faceplate unit with image enhancement;

FIG. 4 schematically depicts a further inclined image output surface of the elongated fiber optics faceplate unit with image enhancement by adjusting;

FIG. 5 schematically depicts an arc formed from the inclined image output surface of the elongated fiber optics faceplate unit with image enhancement by adjusting;

FIG. 6 schematically depicts a forming of the L-shaped optical fiber unit with image enhancement by pressing;

FIG. 7 schematically depicts a forming of two L-shaped optical fiber units with image enhancement by cutting;

FIG. 8 schematically depicts a further inclined image output surface of the L-shaped optical fiber unit with image enhancement by adjusting;

FIG. 9 schematically depicts an arc formed from the inclined image output surface of the L-shapedoptical fiber unit with image enhancement by adjusting;

FIG. 10 is an exploded view of the fiber optics faceplate with image enhancement of FIG. 1;

FIG. 11 schematically depicts a forming of the trapezoidal fiber optics faceplate unit with image enhancement by pressing according to a second preferred embodiment of the invention;

FIG. 12 schematically depicts a forming of two trapezoidal fiber optics faceplate units with image enhancement by cutting;

FIG. 13 schematically depicts further cutting the trapezoidal fiber optics faceplate unit with image enhancement;

FIG. 14 schematically depicts a further inclined image output surface of the trapezoidal fiber optics faceplate unit with image enhancement by adjusting;

FIG. 15 schematically depicts an inward arc formed from the inclined image output surface of the trapezoidal fiber optics faceplate unit with image enhancement by adjusting;

FIG. 16 schematically depicts an outward arc formed from the inclined image output surface of the trapezoidal fiber optics faceplate unit with image enhancement by adjusting;

FIG. 17 schematically depicts a yet further inclined image output surface of the trapezoidal fiber optics unit with image enhancement by adjusting;

FIG. 18 is an exploded view of a fiber optics faceplate with image enhancement according to the second preferred embodiment of the invention;

FIG. 19 is a side elevation of a portion of two joined panels of a large screen having a fiber optics faceplate with image enhancement according to a third preferred embodiment of the invention being disposed between the panels and a plurality of polarizing films being shown; and

FIG. 20 is a side elevation of a portion of two joined panels of a conventional large screen having a poor image being rendered at a joining portion of the panels.

### DETAILED DESCRIPTION OF THE INVENTION

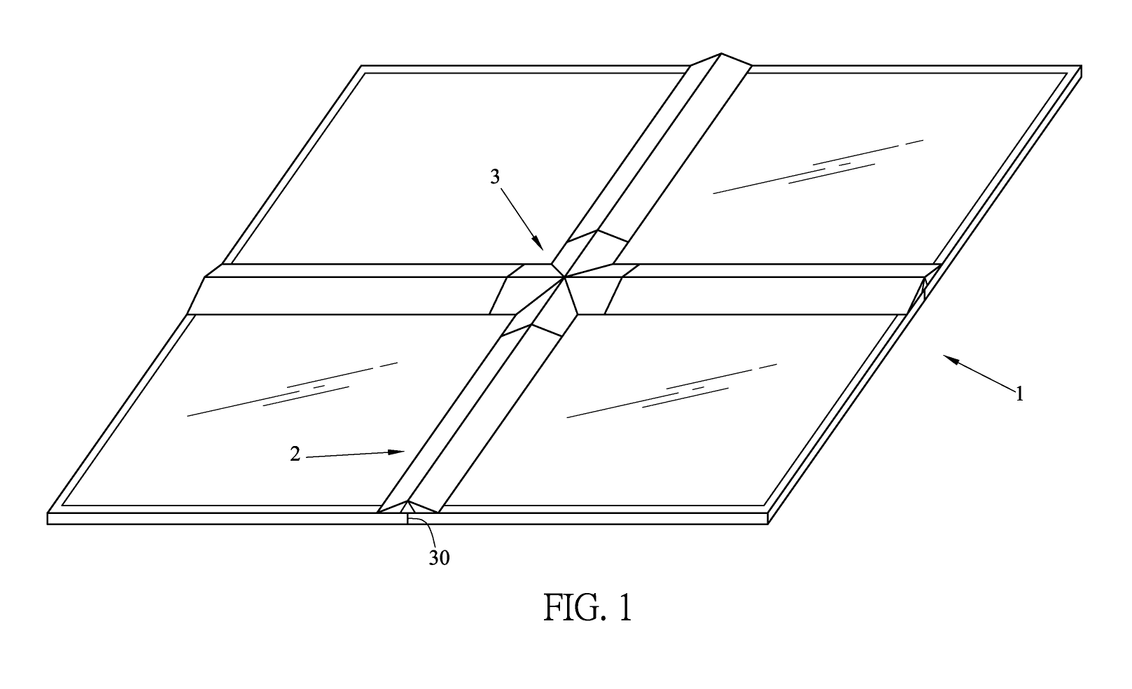

Referring to FIGS. 1 to 10, a fiber optics faceplate 1 with image enhancement in accordance with a first preferred embodiment of the invention comprises the following components as discussed in detail below.

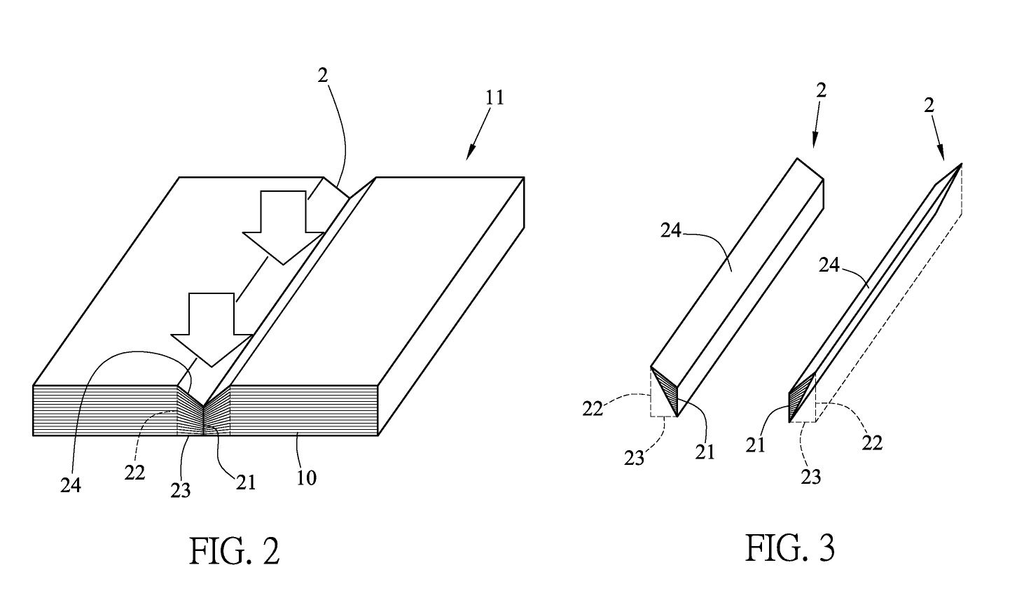

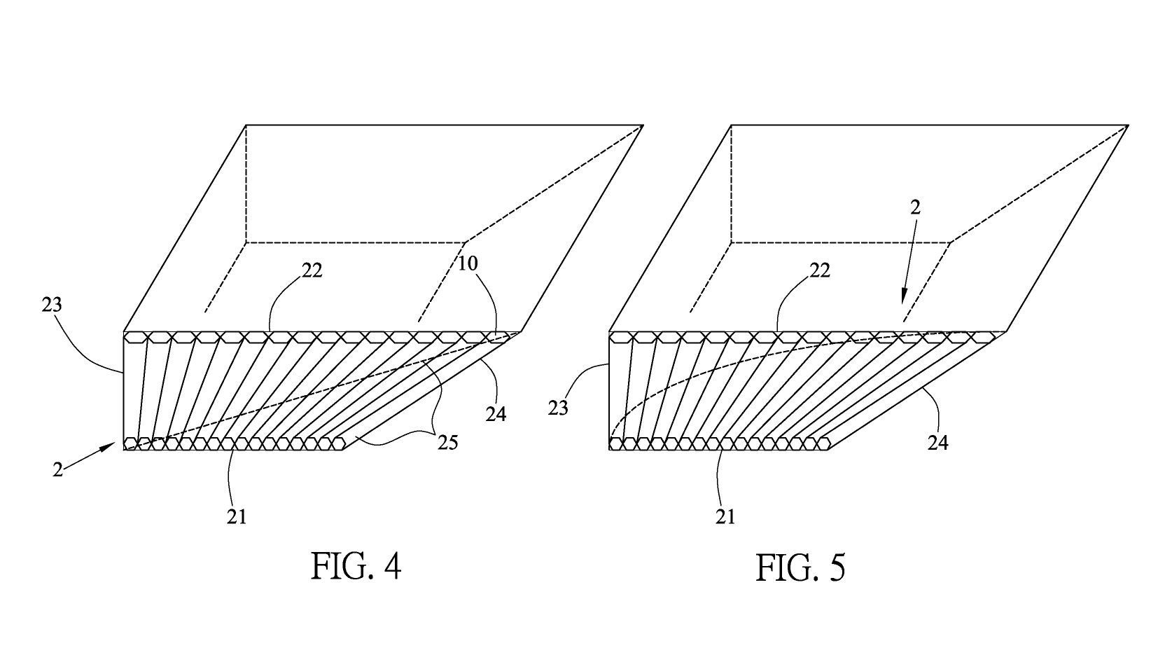

An elongated fiber optics faceplate unit with image enhancement 2 is comprised of a plurality of fiber optics faceplate 10 which have a section of disc, hexagon, square, or rectangle. The fiber optics faceplate 10 is quartz silica base or plastic capable of allowing light to pass through. As shown in FIGS. 2 and 3, the elongated fiber optics faceplate unit with image enhancement 2 is made by molding a fiber optics faceplate section 11 and cutting. The elongated fiber optics faceplate unit with image enhancement 2 comprises an image input surface 21 on a bottom, an image output surface 22 on a top, and a light guide member 25 between the image input surface 21 and the image output surface 22. The elongated fiber optics faceplate unit with image enhancement 2 is a triangular sectional structure, i.e., having a vertical surface 23 and an inclined surface 24. Length of the image output surface 22 is greater than that of the image input surface 21. As shown in FIGS. 4 and 5, the image output surface 22 can be shaped as an arc or cut into a more inclined surface.

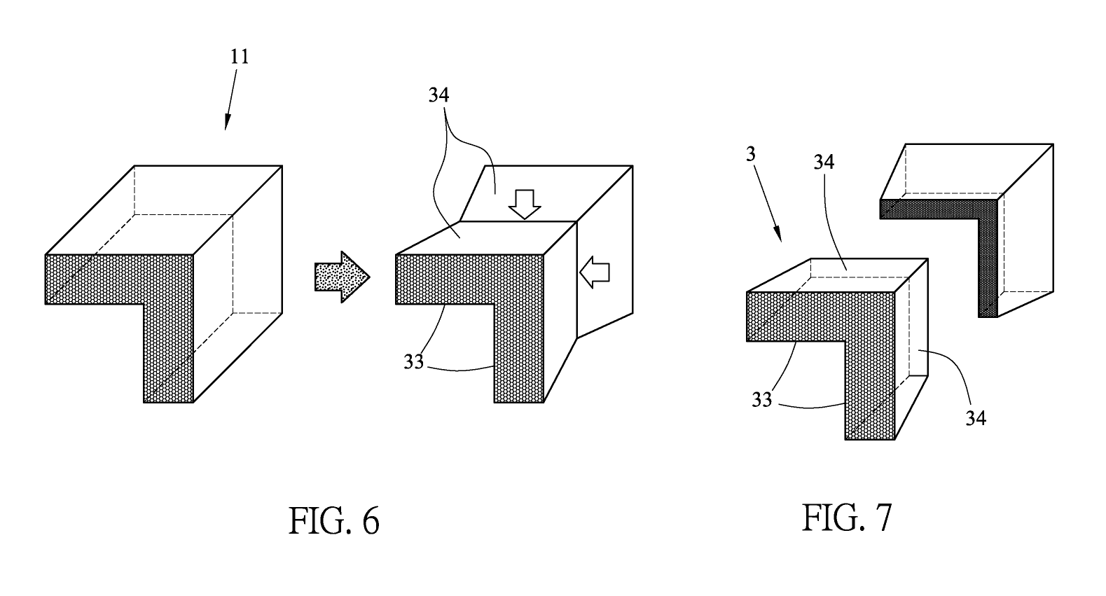

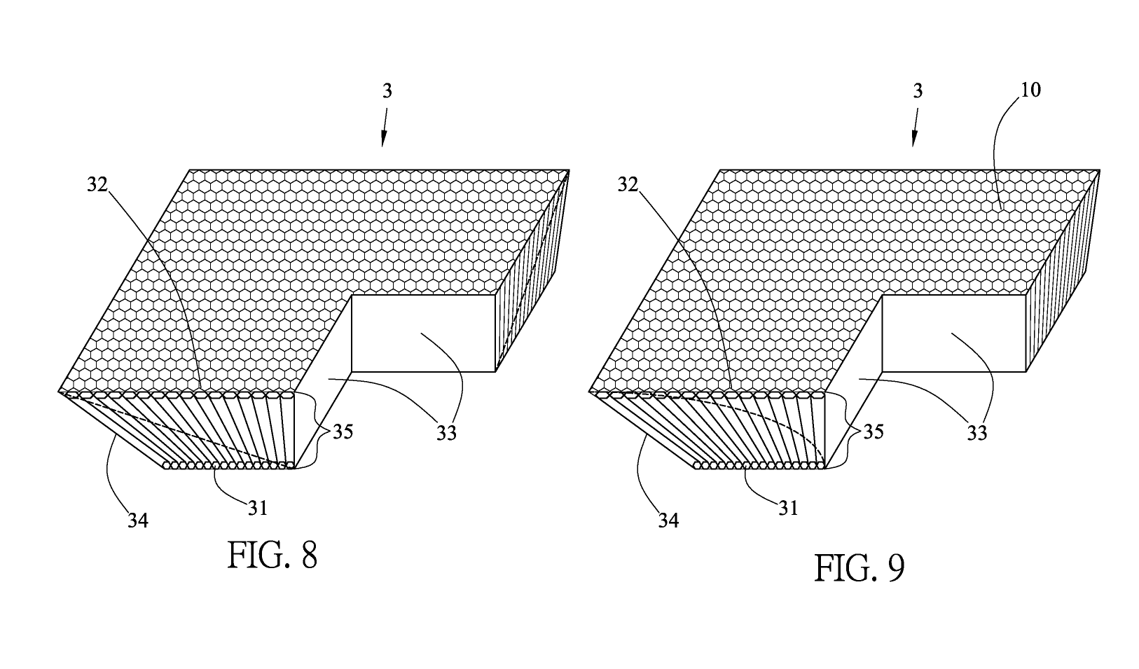

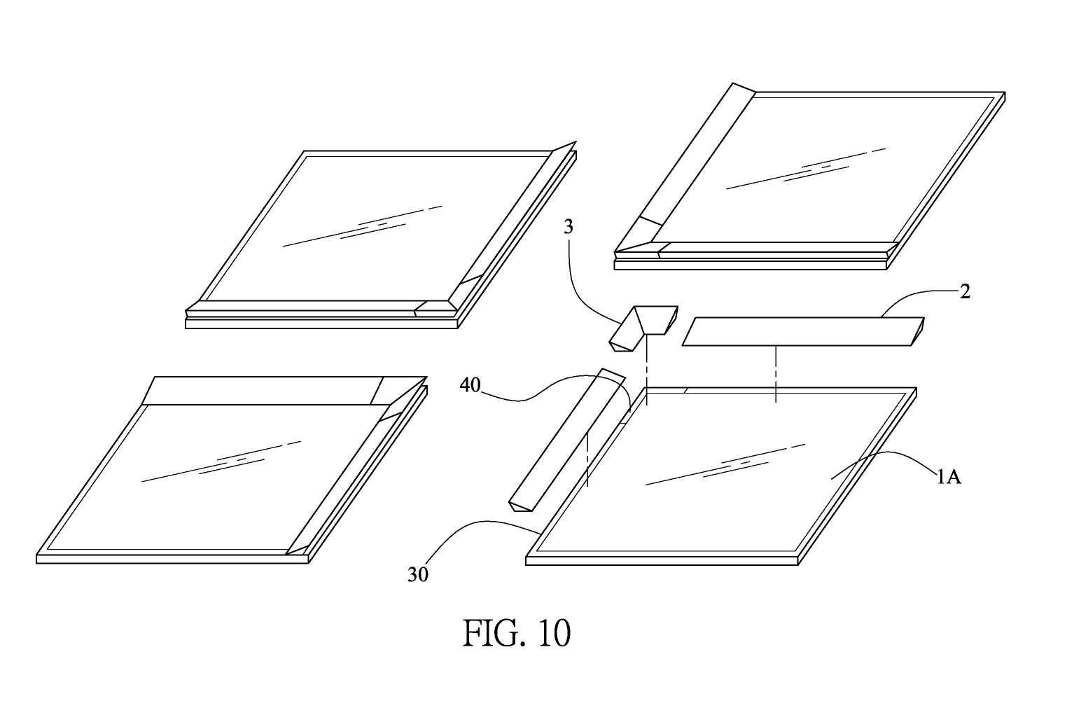

An L-shaped optical fiber unit with image enhancement 3 is comprised of a plurality of fiber optics 10 which have a section of disc, hexagon, square, or rectangle. The fiber optics faceplate 10 is silicate glass or plastic capable of allowing light to pass through. As shown in FIGS. 6 and 7, the L-shaped optical fiber unit with image enhancement 3 is made by molding a corner shaped fiber optics faceplate section 11 and cutting. As shown in FIGS. 8 and 9, the L-shaped optical fiber unit with image enhancement 3 comprises an image input surface 31 on a bottom, an image output surface 32 on a top, and a light guide member 35 between the image input surface 31 and the image output surface 32. The L-shaped optical fiber unit with image enhancement 3 is an inclined structure, i.e., having two inclined surfaces 34 and two vertical surfaces 33 perpendicular to each other being on two parts of the L-shapedoptical fiber unit with image enhancement 3. Length of the image output surface 32 is greater than that of the image input surface 31. The image output surface 32 can be shaped as an arc or cut into a more inclined surface.

As shown in FIGS. 1 and 10, each of the four elongated fiber optics face plate unit with image enhancement 2 are seamlessly fastened in a joining portion 30 of any two adjacent rectangular panels 1A of a large screen and each of the four L-shaped optical fiber unit with image enhancement 3 are seamlessly fastened in one of four corners 40 of the panel 1A by adhesive. Light enters the elongated fiber optic face plate unit with image enhancement 2 through the image input surface 21 and the light leaves the image output surface 22 after passing through the light guide member 25. Also, light enters the L-shapedoptical fiber unit with image enhancement 3 through the image input surface 31 and the light leaves the image output surface 32 after passing through the light guide member 35. As a result, the joining portions 30 and the corners 40 having poor image quality are improved and quality image can be shown on the panels 1A because the panels 1A are joined as a substantially unitary member.

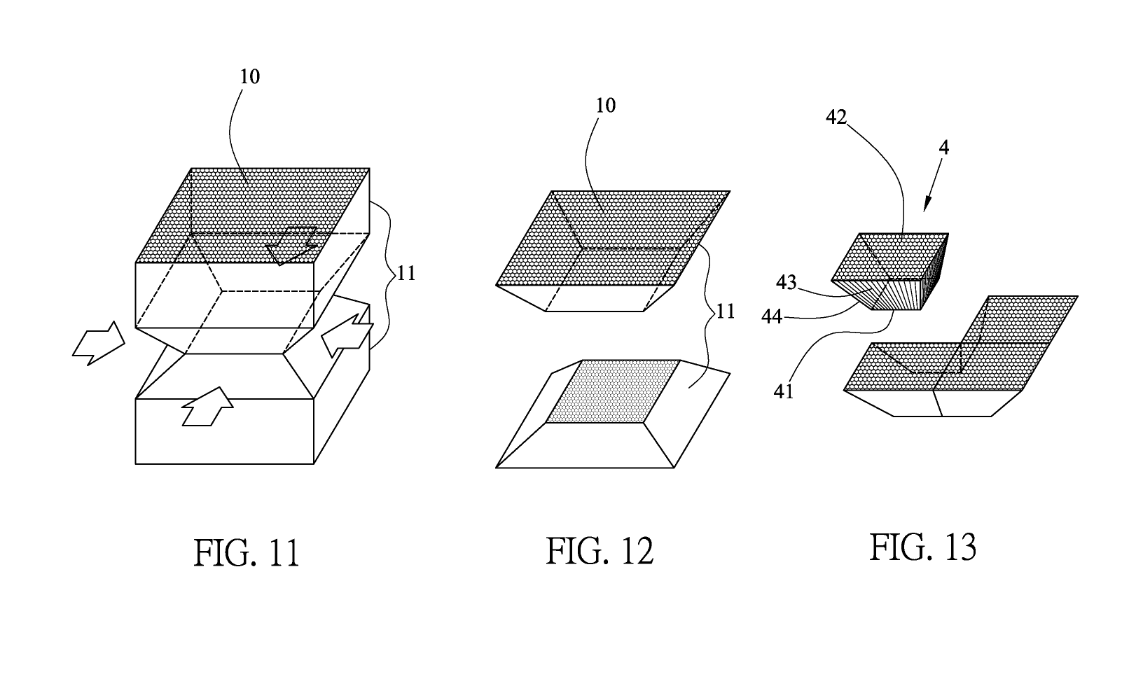

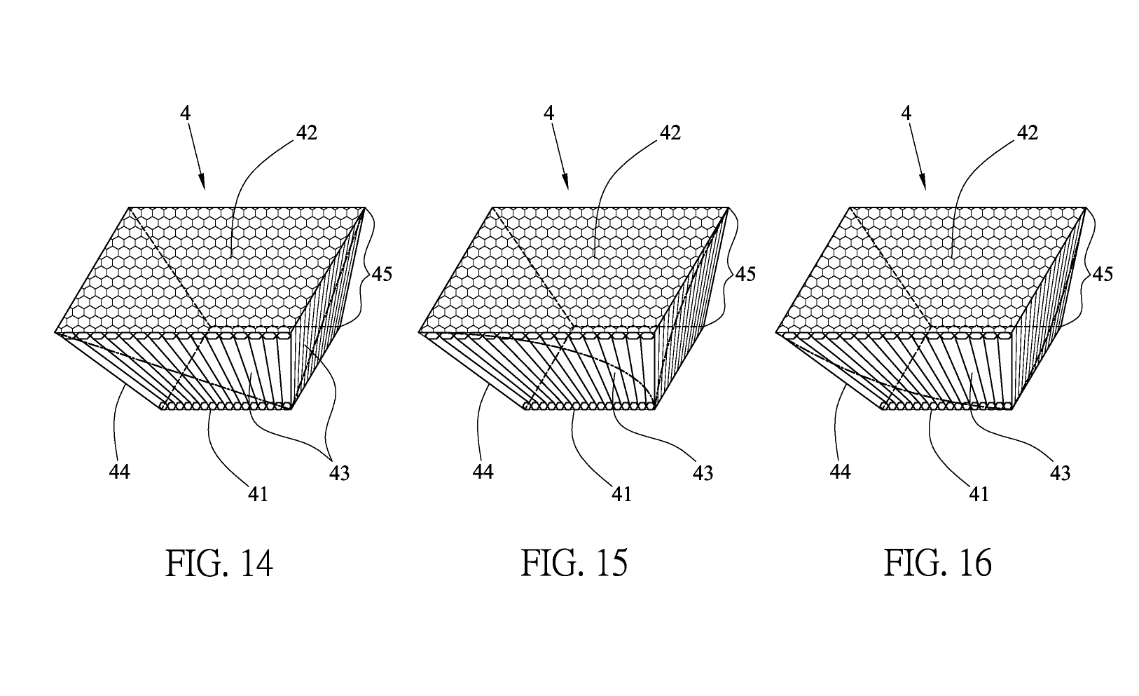

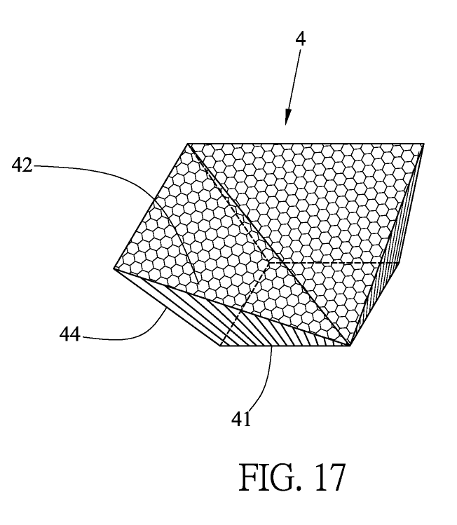

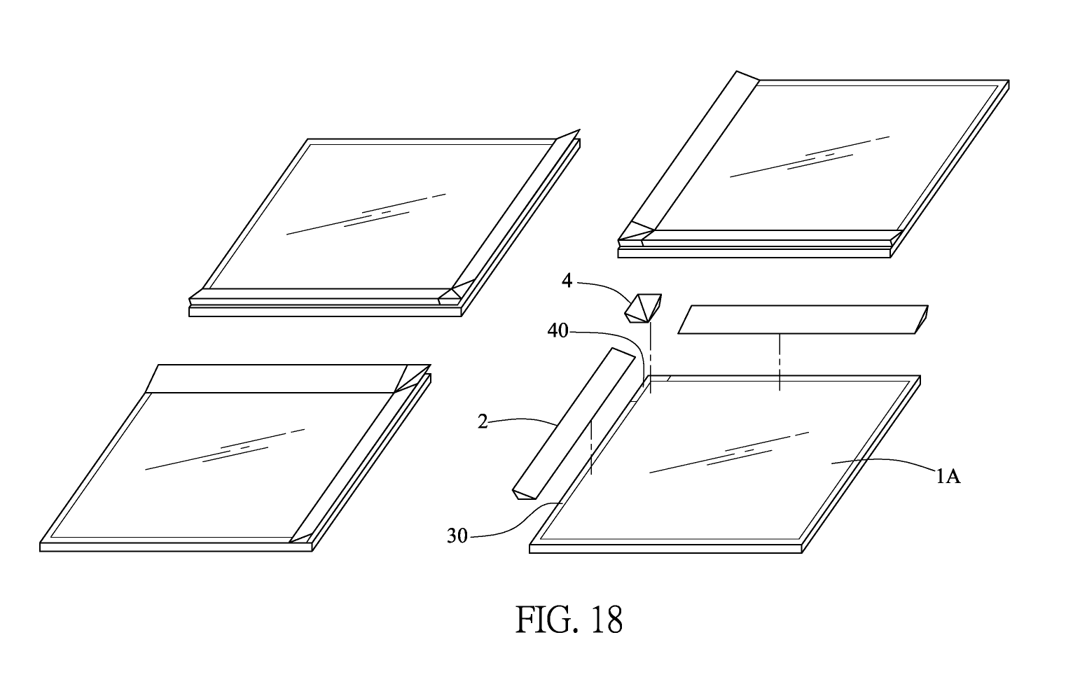

Referring to FIGS. 11 to 18, a fiber optic faceplate with image enhancement in accordance with a second preferred embodiment of the invention is shown. The characteristics of the second preferred embodiment are substantially the same as that of the first preferred embodiment except the following:

A trapezoidal optical fiber unit with image enhancement 4 is comprised of a plurality of fiber optics faceplate 10 which have a section of disc, hexagon, square, or rectangle. The fiber optics faceplate 10 10 is quartz or plastic capable of allowing light to pass through. As shown in FIGS. 11, 12 and 13, the trapezoidal optical fiber unit with image enhancement 4 is made by molding a corner shaped fiber optics faceplate section 11 and cutting. As shown in FIGS. 12 to 17, the trapezoidal optical fiber unit with image enhancement 4 comprises an image input surface 41 on a bottom, an image output surface 42 on a top, and a light guide member 45 between the image input surface 41 and the image output surface 42. The trapezoidal optical fiber unit with image enhancement 4 is a rectangular sectional structure, i.e., having two inclined surfaces 44 and two vertical surfaces 43 joining the inclined surfaces 44 respectively. Length of the image output surface 42 is greater than that of the image input surface 41. The image output surface 42 can be shaped as an arc or cut into a more inclined surface.

Each of the four elongated optical fiber unit with image enhancement 2 are seamlessly fastened in a joining portion 30 of any two adjacent rectangular panels 1A and each of the four trapezoidal optical fiber unit with image enhancement 4 are seamlessly fastened in one of four corners 40 of the panel 1A by adhesive. Light enters the elongated optical fiber unit with image enhancement 2 through the image input surface 21 and the light leaves the image output surface 22 after passing through the light guide member 25. Also, light enters the trapezoidal optical fiber unit with image enhancement 4 through the image input surface 41 and the light leaves the image output surface 42 after passing through the light guide member 45. As a result, the joining portions 30 and the corners 40 having poor image quality are improved and quality image can be shown on the panels 1A because the panels 1A are joined as a substantially unitary member.

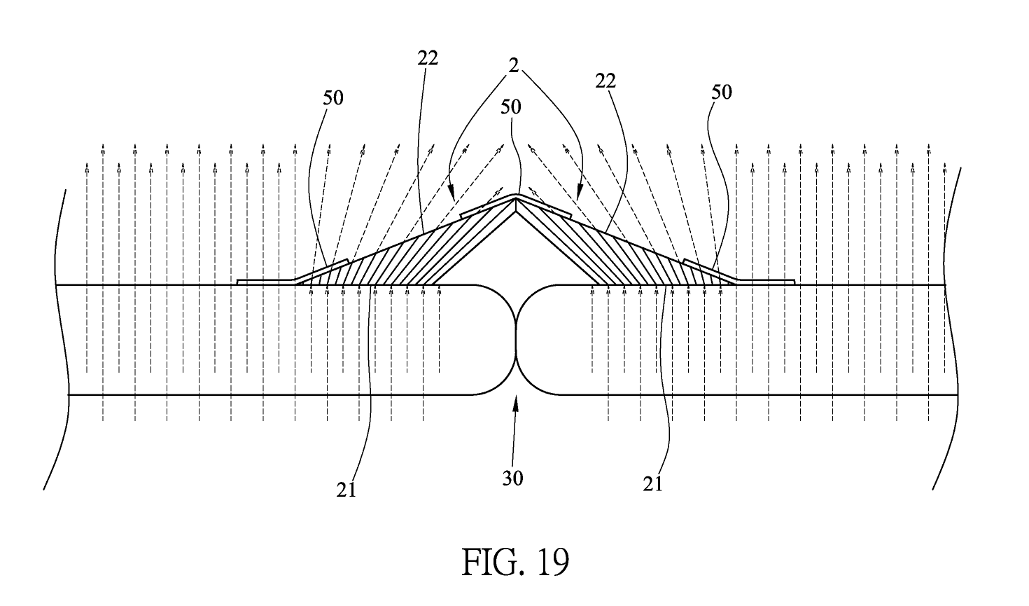

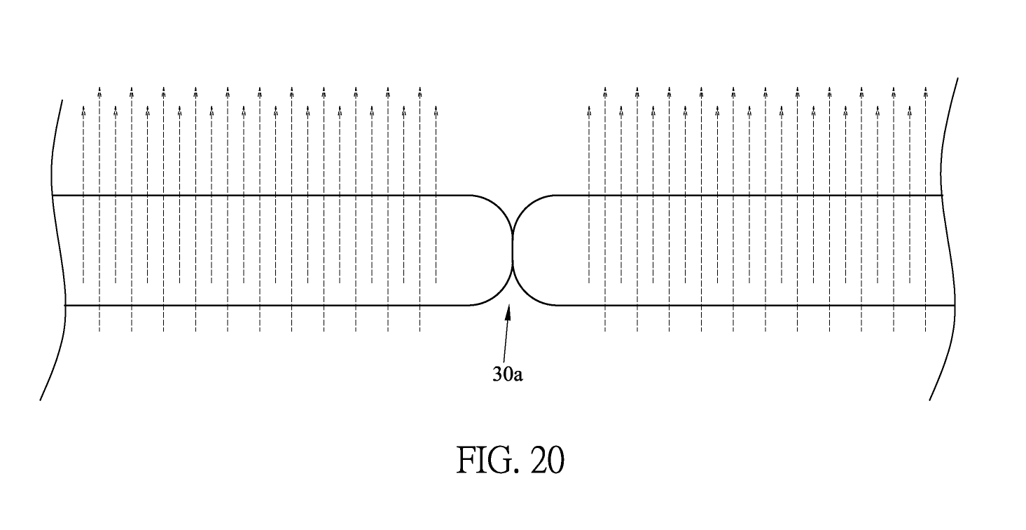

Referring to FIG. 19, an optical fiber with image enhancement in accordance with a third preferred embodiment of the invention is shown. The characteristics of the third preferred embodiment are substantially the same as that of the first preferred embodiment except the following:

As shown in FIGS. 19 in conjunction with FIGS. 1 to 18, each of a plurality of polarizing films 50 are provided between the image output surface 22 and the panel 1A, between one image output surface 22 of the elongated optical fiber unit with image enhancement 2 and one image output surface 22 of the adjacent elongated optical fiber unit with image enhancement 2; between the image output surface 32 and the panel 1A, between one image output surface 32 of the L-shaped optical fiber unit with image enhancement 3 and one image output surface 32 of the adjacent L-shaped optical fiber unit with image enhancement 3; and between the image output surface 42 and the panel 1A, between one image output surface 42 of the trapezoidal optical fiber unit with image enhancement 4 and one image output surface 42 of the adjacent trapezoidal optical fiber unit with image enhancement 4.

Light enters the elongated optical fiber unit with image enhancement 2 through the image input surface 21 and the light leaves the image output surface 22 after passing through the light guide member 25. Also, light enters the trapezoidal optical fiber unit with image enhancement 4 through the image input surface 41 and the light leaves the image output surface 42 after passing through the light guide member 45. Advantageously, the polarizing films 50 can more uniformly distributing the light and increasing view angles. As a result, the joining portions 30 and the corners 40 having poor image quality are improved and quality image can be shown on the panels 1A because the panels 1A are joined as a substantially unitary member.

It is envisaged by the invention that poor image quality at joining portions and corners of any adjacent panels 1A of a large screen experienced by the prior art is greatly improved by seamlessly disposing the elongated optical fiber units with image enhancement 2 and the L-shaped optical fiber units with image enhancement 3 (or the elongated optical fiber unit with image enhancement 2 and the trapezoidal optical fiber unit with image enhancement 4) in the joining portions and the corners respectively wherein light passes through the image input surface, the light guide member, and the image output surface.

While the invention has been described in terms of preferred embodiments, those skilled in the art will recognize that the invention can be practiced with modifications within the spirit and scope of the appended claims.

What is claimed is:

1. An optical fiber comprising, in combination:
a trapezoidal optical fiber unit including an image input surface on a bottom, an image output surface on a top, and a light guide member between the image input surface and the image output surface;
wherein the trapezoidal is a rectangular sectional structure having two inclined surfaces and two vertical surfaces joining the inclined surfaces respectively, and length of the image output surface is greater than that of the image input surface; and
wherein the trapezoidal optical fiber unit is configured to seamlessly fasten in a corner of a rectangular panel so that light is configured to pass through the image input surface, the light guide member, and the image output surface.

2. The optical fiber of claim 1, wherein each of the elongated, the L-shaped, and the trapezoidal fiber optics faceplate units includes a plurality of fiber optics having a section of disc, hexagon, square, or rectangle.

3. The optical fiber of claim 1, wherein the image output surface is configured to shape as an arc curving inward.

4. The optical fiber of claim 1, wherein the image output surface is configured to shape as an arc curving outward.

5. The optical fiber of claim 1, wherein the optical fiber is quartz, silica base glass or plastic capable of allowing light to pass through.

6. The optical fiber of claim 1, further comprising a plurality of polarizing films each disposed between the image output surface and the rectangular panel, between the image output surface of the elongated optical fiber unit and the image output surface of the adjacent elongated optical fiber unit; between the image output surface of the L-shaped optical fiber unit and the rectangular panel, between the image output surface of the L-shaped optical fiber unit and the image output surface of the adjacent L-shaped optical fiber, between the image output surface of the trapezoidal optical fiber unit and the rectangular panel, or between the image output surface of the trapezoidal optical fiber unit and the image output surface of the adjacent trapezoidal optical fiber unit.
